(19) United States
(12) Patent Application Publication
(10) Pub. No.: US 2026/0163656 A1
(43) Pub. Date: Jun. 11, 2026

(54) CUSTOMER PREMISES EQUIPMENT (CPE) DIAGNOSIS OF MOTOR PERFORMANCE DEGRADATION

(71) Applicant: QUALCOMM Incorporated, San Diego, CA (US)

(72) Inventors: Vasanthan RAGHAVAN, West Windsor Township, NJ (US); Junyi LI, Greentown, PA (US); Yu-Chin OU, San Diego, CA (US)

(21) Appl. No.: 18/975,012

(22) Filed: Dec. 10, 2024

(51) Int. Cl. H04B 17/19; H04B 17/309; H04B 17/318

(52) U.S. Cl. CPC H04B 17/19; H04B 17/328; H04B 17/346

(57) ABSTRACT

The present disclosure provides techniques and systems that allow a customer premises equipment (CPE) to perform diagnosis of a performance degradation or failure by the motor of the CPE that is designed or configured to move an antenna panel of the CPE. In some aspects, the CPE may be configured by a network entity such as a base station to self-diagnose any performance degradation or failure by the motor. In other aspects, the network entity may configure the CPE to perform user equipment (UE) assisted-diagnosis of the motor performance degradation or failure. The CPE may determine any performance degradation or failure by the motor and report the same to the network entity.

### TECHNICAL FIELD

The present disclosure is directed to wireless communication systems, apparatus, and methods. Certain embodiments can enable and provide techniques for allowing communication devices (e.g., customer premises equipment (CPE)) to diagnose the performance of a motor moving the antenna panels of the CPE.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices. These multiple communication devices can be user equipment (UE), customer premises equipment (CPE), etc.

To meet the growing demands for expanded mobile broadband connectivity, wireless communication technologies are advancing from the long-term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmW) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

A CPE may include an antenna panel. The antenna panel may be placed/oriented to different spatial directions so that the boresight directions associated with the antenna panel configuration may be different. The CPE may set the antenna panel to a particular antenna configuration and transmit communication signals based on the antenna configuration.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method performed by a CPE includes triggering a motor of the CPE to move an antenna panel of the CPE from a first position to a second position. The method also comprises the CPE determining a performance of the motor based on a comparison of a metric associated with the motion of the antenna panel to an expected operational parameter of the motor.

In an aspect of the disclosure, a CPE comprises a motor, a memory, and a processor. In an aspect, when executing instructions stored on the memory, the processor is configured to trigger the motor to move an antenna panel of the CPE from a first position to a second position. Further, the processor is configured to determine a performance of the motor based on a comparison of a metric associated with the motion of the antenna panel to an expected operational parameter of the motor.

In an aspect of the disclosure, a method performed by a CPE includes the CPE triggering a motor of the CPE to move an antenna panel of the CPE from a first position to a second position. Further, the method comprises the CPE triggering a motor of the CPE to move an antenna panel of the CPE from a first position to a second position. Further, the method comprises the CPE receiving from a UE a signal strength report indicating a strength of a signal transmitted by the CPE during the motion of the antenna panel. In addition, the method comprises the CPE determining a performance of the motor based on a comparison of the signal strength indicated in the signal strength report to an expected signal strength of the CPE during the motion of the antenna panel.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network, in accordance with one or more aspects of the present disclosure.

FIG. 2 illustrates a schematic diagram illustrating the movement of an antenna panel of a customer premises equipment (CPE), in accordance with one or more aspects of the present disclosure.

FIG. 3 illustrates a block diagram of a CPE, in accordance with one or more aspects of the present disclosure.

FIG. 4 illustrates a block diagram of a user equipment (UE), in accordance with one or more aspects of the present disclosure.

FIG. 5 illustrates a block diagram of a base station (BS or gNB), in accordance with one or more aspects of the present disclosure.

FIG. 6 illustrates a signaling diagram illustrating a first example of a CPE diagnosing performance degradation of a motor of the CPE, in accordance with one or more aspects of the present disclosure.

FIG. 7 illustrates a signaling diagram illustrating a second example of a CPE diagnosing performance degradation of a motor of the CPE, in accordance with one or more aspects of the present disclosure.

FIG. 8 illustrates a flow diagram of a first method performed by a CPE diagnosing performance degradation of a motor of the CPE, in accordance with one or more aspects of the present disclosure.

FIG. 9 illustrates a flow diagram of a second method performed by a CPE diagnosing performance degradation of a motor of the CPE, in accordance with one or more aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form to avoid obscuring such concepts.

This disclosure relates generally to wireless communications systems, also referred to as wireless communications networks, and communication devices that utilize the wireless communications networks, such as base station (BS), user equipment (UE), customer premises equipment (CPE), etc. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP 2 ). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The electromagnetic spectrum may be divided into various classes, bands, channels, or other features based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). Further, 3GPP currently defines Frequency Range 3 (FR3) as including 7125 MHz-24,250 MHz.

Communication devices such as a BS, a UE, and/or a CPE can utilize the wireless communication networks to provide connectivity. For example, UEs, CPEs, and/or BSs may communicate with each other using any of the above-identified frequency ranges by utilizing beamforming to improve path loss and range. The functionalities and capabilities of CPEs can include 5G, FR1/sub-6 GHz, FR3, Wi-Fi based on IEEE 802.11 standards, FR2/mmWave, and/or the like, and as such can use these functionalities and capabilities to communicate with other communication devices such as BSs and UEs. As a non-limiting example, CPEs may have one or more of Wi-Fi 4, Wi-Fi 5, Wi-Fi 6, Wi-Fi 6E, Wi-Fi 7 capabilities based on one or more of IEEE 802.11be, 802.11ax, 802.11ac, 802.11n, 802.11g, 802.11b, or 802.11a standards.

A CPE generally refers to telecommunications and information technology equipment kept at a physical location of a customer rather than on the premises of a service provider. CPEs may be used for accessing Internet of Things (IoT) devices or generally accessing services on a service provider network. For example, in an industrial setting, a CPE may provide access to multiple IoT devices widely deployed in one or more factories. CPEs may sit on the customer side of a network and may be a demarcation point between the provider network (e.g., a wide area network-WAN) and a customer home network (e.g., a wireless local area network-WLAN). CPEs may be viewed as fixed wireless access (FWA) routers.

A CPE may effectively serve as a relay between IoT devices (or other types of UEs) and a network entity (such as a 5G/NR base station). In such cases, a CPE may provide a simple interface to the IoT devices, helping keep IoT device cost down. For example, a CPE may interface with IoT devices via Wi-Fi, while still utilizing 5G to connect to a control center, in order to take advantage of the high bandwidth and low latency provided by 5G.

To facilitate the wider adaptation of CPEs in a diverse set of markets, CPEs have evolved from using large antenna arrays to smaller ones that have lower associated cost as the number of circuit components reduces. For example, CPEs can be designed to include smaller 4×4 or 4×2 antenna arrays (compared to larger antenna arrays such as 8×8, 16×8, or 16×16). CPEs with smaller antenna arrays tend to have lower power consumption as well as reduced thermal overhead compared to CPEs with larger antenna arrays. However, the use of smaller antenna arrays may impact a CPE's effective isotropic radiated power (EIRP). To mitigate such effects, a reflector may be utilized to focus and concentrate the radio signals emitted by the CPE's antenna array, thereby providing increased antenna array gain (e.g., as measured by the antenna's EIRP). Examples of such reflectors include a Cassegrain reflector or a mechanical rotator reflector.

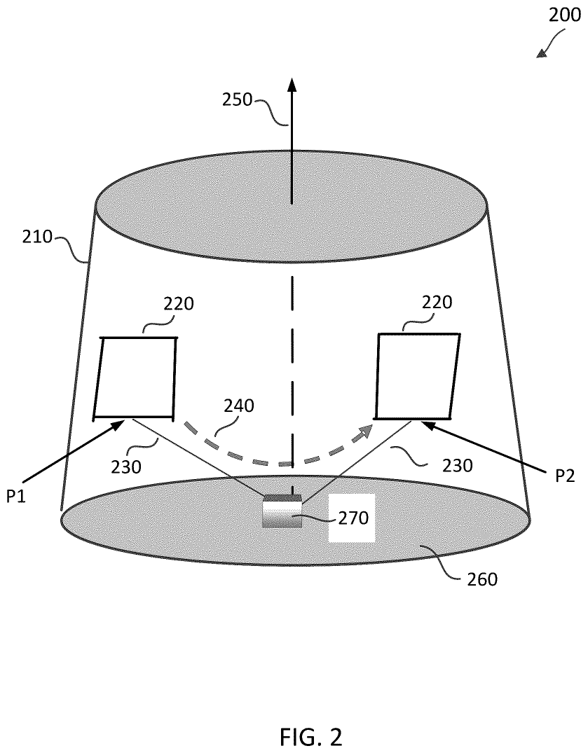

In some aspects, the antenna array and/or the mechanical components may be mounted on a rotator that is controlled by a motor. The motor can cause the antenna array and/or the reflector to move in the CPE so that the radio signal emitted by the antenna array is focused and concentrated and the CPE's EIRP is improved. The movement of the antenna array can be rotational motion and/or translational motion. For example, the antenna array and/or the mechanical components may move rotationally about a single axis (e.g., a vertical axis normal or perpendicular to the plane of the CPE such as the axis 250 that is perpendicular to the plane 260 of the CPE 200 in FIG. 2). As another example, the antenna array and/or the mechanical components may move translationally, i.e., the antenna array and/or the mechanical components may be displaced linearly and change their position translationally. In yet another example, the antenna array and/or the mechanical components may move both translationally and/or rotationally. An antenna array may alternatively be referred to as an antenna panel.

As discussed above, the use of motors to translate and/or rotate an antenna array or panel and/or a mechanical components in a CPE allows the CPE's EIRP to increase (e.g., without the use large antenna arrays). The motor use, however, can have adverse consequences as motors are known to experience performance degradation or failures, adversely affecting the functioning of CPEs. Mechanical motors can fail for a variety of reasons including power supply imbalances as well as mechanical misalignments within the motor. For example, power supply imbalances can include transient voltages, imbalanced voltages, harmonic distortions, etc. CPEs may include protections against such imbalances, but these protections may not be effective at all times.

Mechanical misalignments in a CPE may include angular misalignment and/or parallel misalignment between any two adjacent shafts in the CPE. Angular misalignment includes a misalignment between the adjacent shafts where the respective centerlines are intersecting (i.e., not parallel) while parallel misalignment includes a misalignment between the adjacent shafts where the respective centerlines are parallel (i.e., not intersecting) but are shifted from each other (i.e., the centerlines are displaced from each other laterally and do not overlap).

A motor's failure or performance degradation may affect the performance of the antenna array or panel mounted thereon. For example, motor performance degradation or failure can cause reduction in the speed and/or torque of the motor, increasing the time it takes to linearly translate and/or rotate the antenna panel by a given distance. This may cause sub-par performance by the antenna panel (and thus the CPE), such as, for example, signal transmission with improper signal strength. Alternatively, over a given time period, the distance and/or angular range that is covered by the antenna panel may be reduced as a result of the motor performance degradation or failure. This may also cause sub-par performance by the antenna panel (and thus the CPE), such as, for example, reduced scan angle by the antenna panels. Further, the motor performance degradation or failure can cause increased power consumption (and as a consequence leading to increased thermal overhead), irregular or unexpected translational and/or rotational trajectory, etc. Thus, there is a need for techniques and systems that allow a CPE to perform motor performance degradation diagnosis.

The present disclosure provides techniques and systems that allow a CPE to perform diagnosis of any performance degradation of the motor that is causing translational and/or rotational movement of the antenna array and/or reflector of the CPE. In some aspects, a network entity such as a BS may configure the CPE to perform self-diagnosis of its motor to determine any performance degradation of the motor. In some aspects, the CPE may determine the performance of the motor by using the motor to move the antenna panel of the CPE and comparing a metric associated with the motion of the antenna panel to an expected operational parameter of the motor such as but not limited to a speed, an acceleration, a duration, an energy usage, or a thermal overhead, associated with the motion of the antenna panel.

In some aspects, the network entity may configure the CPE to perform a UE assisted-diagnosis of its motor to determine any performance degradation of the motor. For example, the network entity may configure the CPE to communicate with a UE (which can be configured within the network) that is capable of providing the CPE measurements of the strength of a signal transmitted to the UE by the CPE. The CPE may then determine a performance of the motor based on a comparison of the signal strength indicated in the signal strength report from the UE to an expected signal strength (e.g., a predetermined signal strength corresponding to the signal strength of a brand-new or newly installed CPE). Methods and systems for allowing a CPE to perform diagnosis of a performance motor causing antenna array and/or reflector movement are described in greater detail herein.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects or examples set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

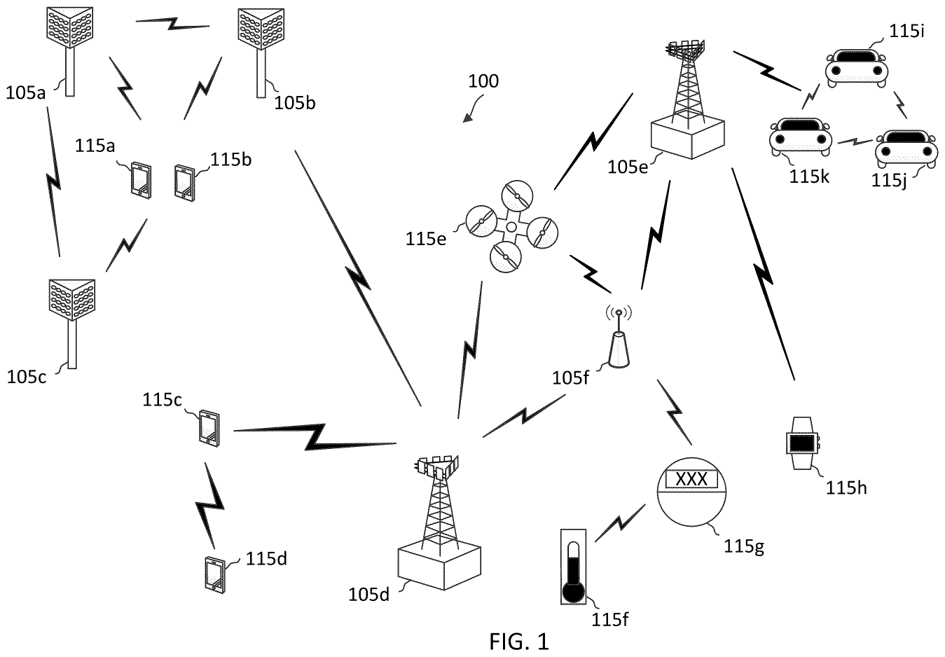

FIG. 1 illustrates a wireless communication network 100 in accordance with one or more aspects of the present disclosure. The network 100 may be a 5G network. The network 100 includes a number of base stations (BSs) 105 (individually labeled as 105 a, 105b, 105 c, 105d, 105e, and 105f) and other network entities. A BS 105 may be a station that communicates with a telecommunications and information technology equipment (generally referred hereinafter as “communication equipment (CE)”) 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. The CE can be a user equipment (UE) or a customer premises equipment (CPE). In some aspects, a UE can be a CPE.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by CEs with service subscriptions with the network provider. A small cell, such as a pico cell, would generally cover a relatively smaller geographic area and may allow unrestricted access by CEs with service subscriptions with the network provider. A small cell, such as a femto cell, would also generally cover a relatively small geographic area (e.g., a home) and, in addition to unrestricted access, may also provide restricted access by CEs having an association with the femto cell (e.g., CEs in a closed subscriber group (CSG), CEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The CEs 115 are dispersed throughout the wireless network 100, and each CE 115 may be stationary or mobile. A CE 115 may also be referred to as a terminal, a mobile station, a subscriber unit, a station, or the like. A CE 115 may be a cellular phone, a personal digital assistant (PDA), a wireless modem, a wireless communication device, a handheld device, a tablet computer, a laptop computer, a cordless phone, a wireless local loop (WLL) station, a UE, a CPE, or the like. A CPE generally refers to a CE kept at a physical location of a customer rather than on the premises of a service provider. A CPE may be viewed as fixed wireless access (FWA) routers.

In one aspect, a CE 115 may be a device that includes a Universal Integrated Circuit Card (UICC). In another aspect, a CE may be a device that does not include a UICC. In some aspects, the CEs 115 that do not include UICCs may also be referred to as IoT devices or internet of everything (IoE) devices. The CEs 115a-115d are examples of mobile smart phone-type devices accessing network 100. A CE 115 may also be a machine specifically configured for connected communication, including machine type communication (MTC), enhanced MTC (eMTC), narrowband IoT (NB-IoT) and the like. The CEs 115e-115h are examples of various machines configured for communication that access the network 100. The CEs 115i-115k are examples of vehicles equipped with wireless communication devices configured for communication that access the network 100. A CE 115 may be able to communicate with any type of the BSs, whether macro BS, small cell, or the like. In FIG. 1, a lightning bolt (e.g., communication links) indicates wireless transmissions between a CE 115 and a serving BS 105, which is a BS designated to serve the CE 115 on the downlink (DL) and/or uplink (UL), desired transmission between BSs 105, backhaul transmissions between BSs, or sidelink transmissions between CEs 115.

In operation, the BSs 105a-105c may serve the CEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmit multicast services which are subscribed to and received by the CEs 115c and 115d. Such multicast services may include mobile television or stream video, or may include other services for providing community information, such as weather emergencies or alerts, Amber alerts, or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the CE 115e, which may be a drone. Redundant communication links with the CE 115e may include links from the macro BSs 105d and 105e, as well as links from the small cell BS 105f. Other machine type devices, such as the CE 115f (e.g., a thermometer), the CE 115g (e.g., smart meter), and CE 115h (e.g., wearable device) may communicate through the network 100 either directly with BSs, such as the small cell BS 105f, and the macro BS 105e, or in multi-step-size configurations by communicating with another user device which relays its information to the network, such as the CE 115f communicating temperature measurement information to the smart meter, the CE 115g, which is then reported to the network through the small cell BS 105f. The network 100 may also provide additional network efficiency through dynamic, low-latency TDD/FDD communications, such as vehicle-to-vehicle (V2V) communications among the CEs 115i-115k, vehicle-to-everything (V2X) communications between a CE 115i, 115j, or 115k and other CEs 115, and/or vehicle-to-infrastructure (V2I) communications between a CE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the SCS between adjacent subcarriers may be fixed, and the total number of subcarriers (K) may be dependent on the system BW. The system BW may also be partitioned into subbands. In other instances, the SCS and/or the duration of TTIs may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. A subframe may also be referred to as a slot. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the CEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information -reference signals (CSI-RSs) to enable a CE 115 to estimate a DL channel. Similarly, a CE 115 may transmit sounding reference signals (SRSs) to enable a BS 105 to estimate a UL channel. Control information may include resource assignments and protocol controls. Data may include protocol data and/or operational data. In some aspects, the BSs 105 and the CEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. An UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a CE 115 attempting to access the network 100 may perform an initial cell search by detecting a PSS from a BS 105. The PSS may enable synchronization of period timing and may indicate a physical layer identity value. The CE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the CE 115 may receive a MIB, which may be transmitted in the physical broadcast channel (PBCH). The MIB may include system information for initial network access and scheduling information for RMSI and/or OSI. After decoding the MIB, the CE 115 may receive RMSI, OSI, and/or one or more system information blocks (SIBs). The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the CE 115 can perform a random access procedure to establish a connection with the BS 105. After establishing a connection, the CE 115 and the BS 105 can enter a normal operation stage, where operational data may be exchanged. For example, the BS 105 may schedule the CE 115 for UL and/or DL communications. The BS 105 may transmit UL and/or DL scheduling grants to the CE 115 via a PDCCH. The scheduling grants may be transmitted in the form of DL control information (DCI). The BS 105 may transmit a DL communication signal (e.g., carrying data) to the CE 115 via a PDSCH according to a DL scheduling grant. The CE 115 may transmit an UL communication signal to the BS 105 via a PUSCH and/or PUCCH according to an UL scheduling grant. In some aspects, the BS 105 may communicate with a CE 115 using HARQ techniques to improve communication reliability, for example, to provide a URLLC service.

In some aspects, the network 100 may operate over a system BW or a component carrier (CC) BW. The network 100 may partition the system BW into multiple BWPs (e.g., portions). A BS 105 may dynamically assign a CE 115 to operate over a certain BWP (e.g., a certain portion of the system BW). The assigned BWP may be referred to as the active BWP. The CE 115 may monitor the active BWP for signaling information from the BS 105. The BS 105 may schedule the CE 115 for UL or DL communications in the active BWP. In some aspects, a BS 105 may assign a pair of BWPs within the CC to a CE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the CEs 115 may be operated by multiple network operating entities.

In some aspects, CEs 115 (e.g., CE 115c and 115d) may communicate with each other via sidelink communication links. Sidelink communications refers to the communications among CEs 115 without tunneling through a BS 105 and/or a core network. Sidelink communication can be communicated over a physical sidelink control channel (PSCCH) and a physical sidelink shared channel (PSSCH). The PSCCH and PSSCH are analogous to a PDCCH and a PDSCH in DL communication between a BS and a CE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. Use cases for sidelink communication may include communication between a CPE 115 and a UE 115.

FIG. 2 illustrates an example CPE 200 in accordance with one or more aspects of the present disclosure. The CPE 200 may be a CE 115 discussed above in FIG. 1. In the example illustrated in FIG. 2, the CE 200 includes an antenna panel 220 and a motor 270 that is configured to move 240 the antenna panel 220 from a first position P1 to a second position P2. The antenna panel 220 may also be referred to as a panel, an antenna array, or a motorized antenna panel. In some aspects of the disclosure, and as shown in FIG. 2, the antenna panel 220 may be situated in an enclosure 210 of the CPE 200. In other aspects of the disclosure, the antenna panel 220 may be situated outside of the enclosure 210. That is, in some aspects, one of the positions P1 or P2 can be situated within the enclosure 210 (while the other one is outside the enclosure), both of the positions P1 or P2 can be situated within the enclosure 210, or both of the positions P1 or P2 can be situated outside the enclosure 210.

In some aspects, the antenna panel 220 may be coupled to the motor 270 via a coupling element 230 (e.g., such as a shaft). For example, the coupling element 230 may be a rotatable shaft and a proximal end of the rotatable shaft may be attached to the motor 270 while the distal end of the rotatable shaft may be attached to the antenna panel 220. In other cases, the coupling element can be a rotator coupled to the motor 270 and the antenna panel 220 may be mounted on the rotator. In either case, the motor 270 may be capable of rotating 240 the antenna panel 220 from its first position P1 to its second position P2. The rotation direction can be clockwise or counterclockwise.

In some aspects, the coupling element 230 can be a traveling shaft. In such cases, the motor may be capable of moving 240 the antenna panel 220 from its position P1 to its second position P2 in one or more linear motions (e.g., via the traveling shaft). That is, the motor 270 may be configured to move the traveling shaft such that the antenna panel 220 moves 240 in a plane coinciding with or parallel to the bottom plane 260 of the enclosure 210 of the CPE 200. For example, the axis 250 may define the z-axis of the enclosure 210, and the motor 270 may cause the antenna panel 220 to move 240 in the x-direction and/or y-direction on the bottom plane 260 or on a plane parallel to the bottom plane 260. Further, the motor 270 may cause the antenna panel to move 240 along the axis 250, i.e., the z-direction (e.g., the traveling shaft may be retractable).

In some aspects, the antenna panel 220 of the CPE 200 may be capable of applying beamforming techniques to communicate with other CEs, such as a BS or a UE. In some cases, the antenna panel 220 may be in the form of a single panel or multiple panels (e.g., arranged in an array). Each antenna panel 220 may include a plurality of antenna ports or elements in a vertical dimension and/or a plurality of antenna ports or elements in a horizontal dimension. The CPE 200 may form beams in different of angular directions by weighting signal phases and amplitudes at the antenna elements.

In some aspects, the antenna panel 220 may be associated with a plurality of antenna configurations. An antenna configuration may include parameters that control or are associated with the antenna panel 220. For example, the antenna configuration may include a set of orientations (e.g., angle or boresight direction) of the antenna panel, a set of channel frequencies for transmitting communication signals based on the panel orientation, and the like. The antenna panel 220 may be a directional antenna having a front surface and a boresight direction. In some examples, the boresight direction is perpendicular to the front surface of the antenna panel 220. In some examples, the boresight direction may represent the axis of maximum gain of the antenna panel 220.

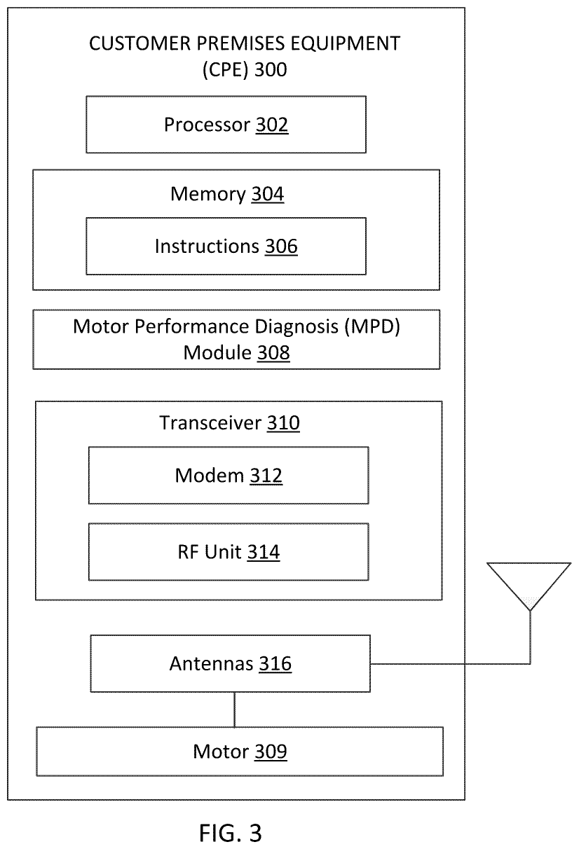

In some aspects, the CPE 200 may have a power source that powers the motor 270. For example, the CPE 200 may be battery-powered or powered via an electrical outlet. The CPE 200 may also include a processor that is configured to perform the methods disclosed herein that allow the CPE 200 to determine performance degradation of the motor 270. For example, the processor may be in communication with the motor 270 and may be capable of transmitting a control signal to motor 270 to control the movement of the antenna panel 220 as described herein. Further, the CPE 200 may include a transceiver that allows the CPE 200 to communicate with a BS and/or a UE (e.g., to report motor performance degradation or failure to the BS, to receive CPE signal strength measurements from the UE, and/or receive configuration from the BS configuring the CPE 200 with self-diagnosis mode or UE assisted-diagnosis mode). Further details on the CPE 200 and its capabilities are described below with respect to FIG. 3.

FIG. 3 illustrates a block diagram of a CPE 300 in accordance with one or more aspects of the present disclosure. The CPE 300 may be a CE 115 discussed above in FIG. 1 and/or a CPE 200 discussed above in FIG. 2. As shown, the CPE 300 may include a processor 302, a memory 304, a motor performance diagnosis (MPD) module 308, a transceiver 310 including a modem subsystem 312 and a radio frequency (RF) unit 314, and one or more antennas 316. These elements may be in direct or indirect communication with each other, for example via one or more buses. Further, the CPE 300 may also include a motor 309 that is coupled to the one or more antennas 316.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to the CPEs in connection with aspects of the present disclosure, for example, aspects of FIGS. 1, 2, and 6-9. Instructions 306 may also be referred to as program code. The program code may be for causing a wireless communication device to perform these operations, for example, by causing one or more processors (such as processor 302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The MPD module 308 may be implemented via hardware, software, or combinations thereof. The MPD module 308 may be implemented as a processor, circuit, and/or instructions 306 stored in the memory 304 and executed by the processor 302. In some instances, the MPD module 308 can be integrated within the modem subsystem 312. The MPD module 308 can be implemented by a combination of software components (e.g., executed by a DSP or a general processor) and hardware components (e.g., logic gates and circuitry) within the modem subsystem 312. The MPD module 308 may be used for various aspects of the present disclosure, for example, aspects of FIGS. 1, 2, and 6-9.

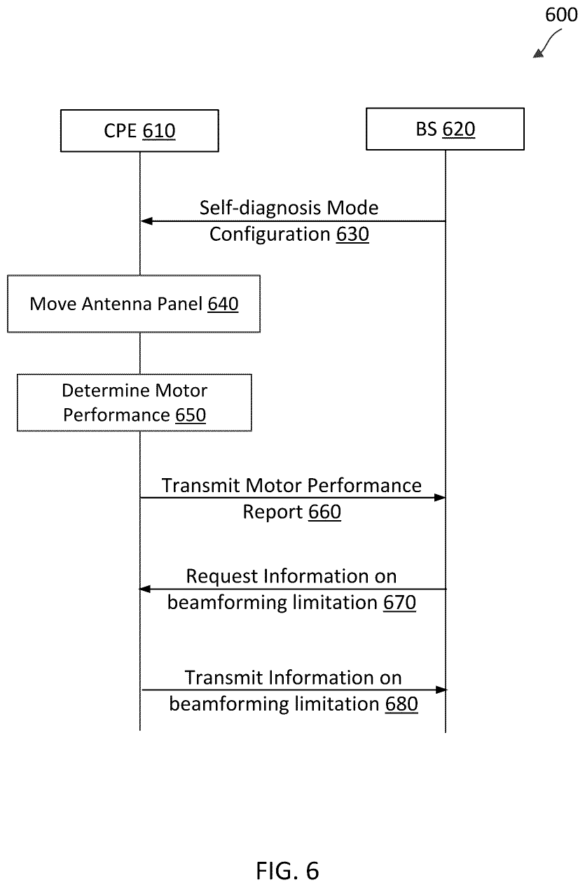

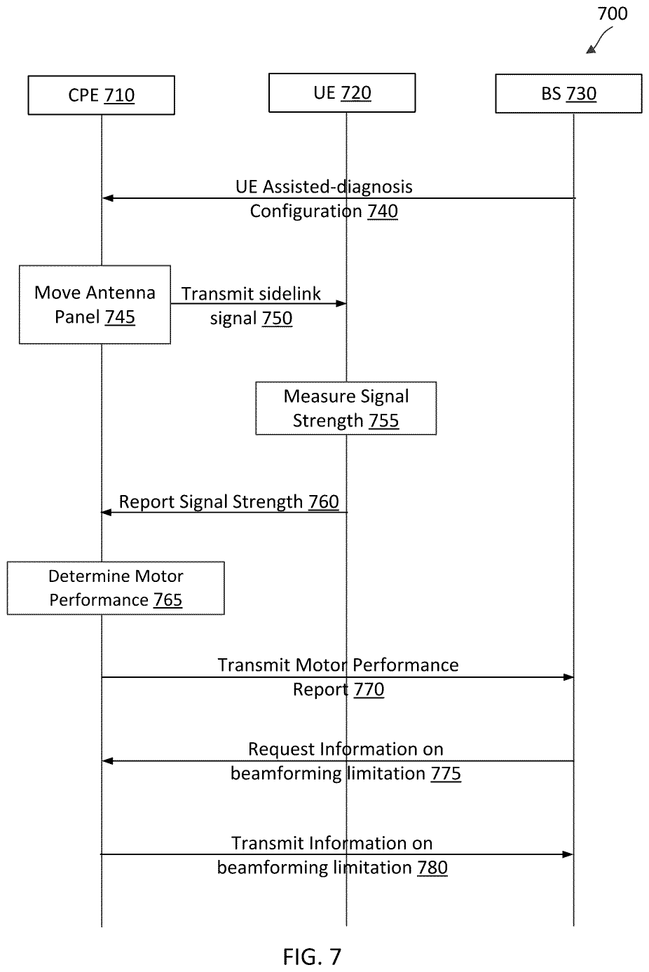

In some aspects, the MPD module 308 may be configured to cause the CPE 300 trigger the motor 309 to move the antennas 316 from a first position to a second position. Further, the MPD module 308 may be configured to determine the performance of the motor 309 moving the antennas 316 from the first position to the second position. The MPD module 308 may determine, for example using the processor 302, the motor performance based on a self-diagnosis mode, described in more detail below (particularly with reference to FIG. 6), or based on a UE-assisted diagnosis mode, described in more detail below also (particularly with reference to FIG. 7). In some aspects, the MPD module 308 may also be configured to cause the transmission, to a network entity such as a BS, of a report on the performance of the motor and information on beamforming limitations caused by any performance degradation or failure by the motor. Further, the MPD module 308 may also be configured to cause the reception, by the CPE 300 from a network entity such as a BS, of a request for information on the beamforming limitations. In addition, the MPD module 308 may also be configured to cause the transmission, by the CPE 300 to a UE in the same network, of a sidelink signal via a sidelink communication channel, and receive from the UE, a signal strength report indicating the strength of the signal transmitted by the CPE 300. For example, the MPD module 308 may use the transceiver 310 for the transmissions and/or the receptions.

As shown, the transceiver 310 may include the modem subsystem 312 and the RF unit 314. The transceiver 310 can be configured to communicate bi-directionally with other devices, such as the BSs 105, CEs 115, the UE 400, and/or the BS 500. The modem subsystem 312 may be configured to modulate and/or encode the data from the memory 304 and/or the MPD module 308 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data (e.g., motor performance report, beamforming limitations information, sidelink signal, etc.) from the modem subsystem 312 (on outbound transmissions) or of transmissions originating from another source such as a CE 115, CPE 200, UE 400, or a BS 105, 500. The RF unit 314 may be further configured to perform analog beamforming in conjunction with the digital beamforming. Although shown as integrated together in transceiver 310, the modem subsystem 312 and the RF unit 314 may be separate devices that are coupled together at the CPE 300 to enable the CPE 300 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., RRC configurations, SSBs, SIBs, RMSIs, reference signals, signal strength reports, beamforming limitation information request, etc.) to the MPD module 308 for processing. The antennas 316 may include multiple antennas of similar or different designs to sustain multiple transmission links. For example, the antennas 316 may correspond to antennas in the antenna panel 220 in FIG. 2. The RF unit 314 may configure the antennas 316.

In some aspects, the transceiver 310 may coordinate with the MPD module 308 to communicate to a network entity such as a BS a report on the performance of the motor 309 of the CPE 300 moving the antennas 316 from a first position to a second position. The transceiver 310 may also coordinate with the MPD module 308 to transmit information on beamforming limitations caused by any performance degradation or failure by the motor and/or a sidelink signal via a sidelink communication channel. Further, the transceiver 310 may coordinate with the MPD module 308 to receive, from a network entity such as a BS, a request for information on the beamforming limitations and from the UE, a signal strength report indicating the strength of the signal transmitted by the CPE 300.

In some aspects, the motor 309 can be any motor of the CPE 300 that is capable of moving the antennas 316 from one position to another position, either in linearly (e.g., x-direction, y-direction, and/or z-direction) or angularly (e.g., clockwise and/or anticlockwise). In some aspects, the motor 309 may be coupled, either directly or via an intermediary component, such that the motor 309 can move (e.g., translate and/or rotate) the antennas 316 when caused to do so by the MPD module 308.

In some aspects, the CPE 300 can include multiple transceivers 310 implementing different radio access technologies (RATs) (e.g., NR and LTE). In an aspect, the CPE 300 can include a single transceiver 310 implementing multiple RATs (e.g., NR and LTE). In an aspect, the transceiver 310 can include various components, where different combinations of components can implement different RATs.

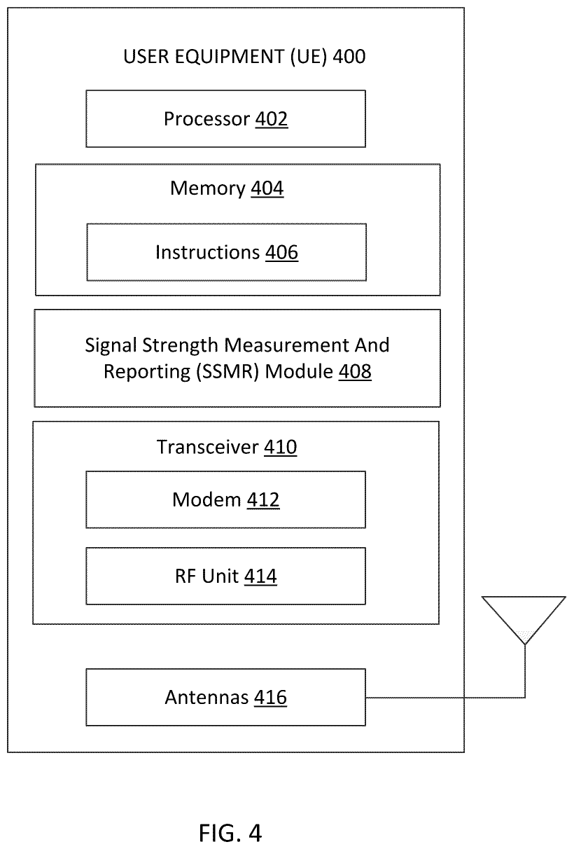

FIG. 4 illustrates a block diagram of a UE 400 in accordance with one or more aspects of the present disclosure. The UE 400 may be a CPE 115 discussed above in FIG. 1. As shown, the UE 400 may include a processor 402, a memory 404, signal strength measurement and reporting (SSMR) module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs in connection with aspects of the present disclosure, for example, aspects of FIGS. 1, 7, and 9. Instructions 406 may also be referred to as program code. The program code may be for causing a wireless communication device to perform these operations, for example, by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SSMR module 408 may be implemented via hardware, software, or combinations thereof. The SSMR module 408 may be implemented as a processor, circuit, and/or instructions 406 stored in the memory 404 and executed by the processor 402. In some instances, the SSMR module 408 can be integrated within the modem subsystem 412. The SSMR module 408 can be implemented by a combination of software components (e.g., executed by a DSP or a general processor) and hardware components (e.g., logic gates and circuitry) within the modem subsystem 412. The SSMR module 408 may be used for various aspects of the present disclosure, for example, aspects of FIGS. 1, 7, and 9.

In some aspects, the SSMR module 408 may be configured to cause the reception, by the UE 400 and from a CPE, of a signal via a sidelink communication channel. Further, the SSMR module 408 may be configured to cause the UE 400 to measure, for example using the processor 402, the strength of the signal transmitted by the CPE. In addition, the SSMR module 408 may also be configured to cause transmission, by the UE 400 and to the CPE, of a signal strength report indicating the strength of the signal. For example, the SSMR module 408 may use the transceiver 410 for the transmissions and/or the receptions.

As shown, the transceiver 410 may include the modem subsystem 412 and the RF unit 414. The transceiver 410 can be configured to communicate bi-directionally with other devices, such as the BSs 105, CEs 115, CPE 300, or BS 500. The modem subsystem 412 may be configured to modulate and/or encode the data from the memory 404 and/or the SSMR module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., signal strength measurements, etc.) from the modem subsystem 412 (on outbound transmissions) or of transmissions originating from another source such as a UE 115, 200 or a BS 105, 400. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 400 to enable the UE 400 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., RRC configurations, SSBs, SIBs, RMSIs, reference signals, etc.) to the SSMR module 408 for processing. The antennas 416 may include multiple antennas of similar or different designs to sustain multiple transmission links. The RF unit 414 may configure the antennas 416.

In some aspects, the transceiver 410 may coordinate with the SSMR module 408 to receive from a CPE of a signal via a sidelink communication channel. Further, the transceiver 410 may coordinate with the SSMR module 408 transmit to the CPE a signal strength report indicating the strength of the signal.

In some aspects, the UE 400 can include multiple transceivers 410 implementing different radio access technologies (RATs) (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

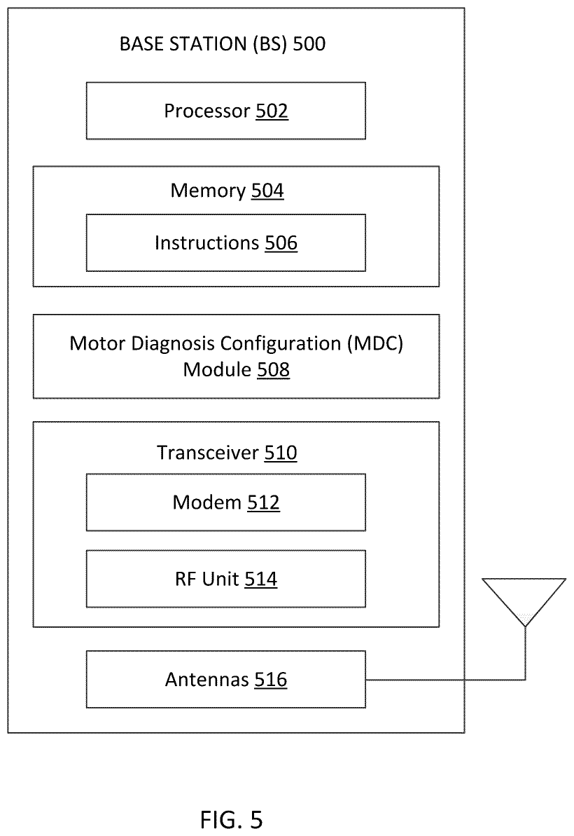

FIG. 5 illustrates a block diagram of a BS 500 in accordance with one or more aspects of the present disclosure. The BS 500 may be a BS 105 as discussed above in FIG. 1. As shown, the BS 500 may include a processor 502, a memory 504, a motor diagnosis configuration (MDC) module 508, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIG. 1, and 5-9. Instructions 506 may also be referred to as code, which may be interpreted broadly to include any type of computer-readable statement(s) as discussed above with respect to FIG. 3.

The MDC module 508 may be implemented via hardware, software, or combinations thereof. The MDC module 508 may be implemented as a processor, circuit, and/or instructions 506 stored in the memory 504 and executed by the processor 502. In some instances, the MDC module 508 can be integrated within the modem subsystem 512. The MDC module 508 can be implemented by a combination of software components (e.g., executed by a DSP or a general processor) and hardware components (e.g., logic gates and circuitry) within the modem subsystem 512. The MDC module 508 may be used for various aspects of the present disclosure, for example, aspects of FIG. 1, and 5-9.

In some aspects, the MDC module 508 may be configured to communicate to a CPE a configuration to configure the CPE to perform a motor performance self-diagnosis mode and/or UE assisted-diagnosis mode. Further, the MDC module 508 may be configured to cause the reception, from the CPE, of a CPE motor performance degradation or failure report and/or information on beamforming limitations as a result of any performance degradation or failure. The MDC module 508 may be configured to cause transmission, from the BS 500 and to the CPE, of a request requesting the information on the beamforming limitations. For example, the MDC module 508 may use the transceiver 510 for the transmissions and/or the receptions.

As shown, the transceiver 510 may include the modem subsystem 512 and the RF unit 514. The transceiver 510 can be configured to communicate bi-directionally with other devices, such as CEs 115, CPE 200, 300, BSs 105, and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., RRC configurations, SSBs, beamforming limitation information request, expected signal strength, etc.) from the modem subsystem 512 (on outbound transmissions) or of transmissions originating from another source such as a CE 115, CPE 200, 300, or UE 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 500 to enable the BS 500 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped CPE 115, 200, 300 or UE 400 according to some aspects of the present disclosure. The antennas 516 may further receive data messages transmitted from other devices and provide the received data messages for processing and/or demodulation at the transceiver 510. The transceiver 510 may provide the demodulated and decoded data (e.g., motor performance report, beamforming limitation information, etc.) to the MDC module 508 for processing. The antennas 516 may include multiple antennas of similar or different designs in order to sustain multiple transmission links.

In some aspects, the transceiver 510 may coordinate with the MDC module 508 to communicate a configuration to the CPE to configure the CPE with a motor performance self-diagnosis mode and/or a UE assisted-diagnosis mode. Further, the transceiver 510 may receive, from the CPE, a CPE motor performance degradation or failure report and/or information on beamforming limitations as a result of any performance degradation or failure. The transceiver 510 may also transmit, from the BS 500 and to the CPE, a request requesting the information on the beamforming limitations.

In some aspects, the BS 500 can include multiple transceivers 510 implementing different RATs (e.g., NR and LTE). In an aspect, the BS 500 can include a single transceiver 510 implementing multiple RATs (e.g., NR and LTE). In an aspect, the transceiver 510 can include various components, where different combinations of components can implement different RATs.

FIG. 6 illustrates a signaling diagram illustrating a first method 600 of a CPE diagnosing performance degradation or failure of a motor of the CPE, in accordance with one or more aspects of the present disclosure. The method 600 is implemented between a CPE 610 (e.g., the CEs 115, CPE 200, 300) and a BS 620 (e.g., the BSs 105 and 500) in a network (e.g., the network 100). Steps of the method 600 can be executed by computing devices (e.g., a processor, processing circuit, and/or other suitable component) of the CPE 610 and the BS 620. As illustrated, the method 600 includes a number of enumerated steps, but aspects of the method 600 may include additional steps before, after, and in between the enumerated steps. In some aspects, one or more of the enumerated steps may be omitted or performed in a different order. The method 600 may employ any suitable combinations of features described herein with respect to FIGS. 1-3, and 6-9.

At step 630, the BS 620 transmits to the CPE 610 a configuration to configure the CPE with a self-diagnosis mode. In some aspects, the configuration may be transmitted via a signaling message (e.g., over-the-air signaling) such as but not limited to a radio resource control (RRC), a physical downlink control channel (PDCCH) downlink control information (DCI), group-common-PDCCH (GC-PDCCH) DCI, and/or a multiple access channel-control element (MAC-CE). In some aspects, the self-diagnosis mode configuration may configure the CPE 610 to perform tests or checks to determine the health or performance of the motor of the CPE 610 that is coupled to the antenna panel of the CPE 610. As discussed above, the CPE 610 may have a motor (e.g., such as the motor 270 in FIG. 2 or motor 309 in FIG. 3) that is coupled to antenna panel of the CPE 610 and is configured to move the antenna panel. The self-diagnosis mode configuration then configures the CPE 610 to perform health check on the motor, i.e., to determine any performance degradation or failure associated with the motor of the CPE 610. The terms “motor health check” and “motor performance degradation/failure diagnosis” may be used interchangeably.

In some aspects, the configuration may indicate details of the self-diagnosis mode such as but not limited to the periodicity of the motor health check. For example, the configuration may configure the CPE 610 to self-diagnose motor performance degradation or failure regularly. For instance, the CPE 610 may be configured by the configuration to perform motor performance degradation self-diagnosis every predetermined number of seconds, minutes, hours, days, weeks, months, etc. In some aspects, the periodicity can depend on the age of the CPE 610 and/or can be dynamic. For example, the configuration may indicate that as the CPE 610 ages, the periodicity of the motor health checks should decrease, i.e., the frequency of the motor health checks should increase. For instance, the configuration may specify that for every predetermined number of years (e.g., for every year) that the CPE 610 ages, the CPE 610 may perform motor performance degradation self-diagnosis a predetermined number of times (e.g., one additional motor health check). It is to be appreciated that this is an exemplary aspect and the periodicity of the motor health check can be changed based on the age of the CPE 610 in any manner consistent with the discussion herein.

In some aspects, the configuration may also indicate a condition that has to be met for the CPE 610 to perform a health check on the motor, i.e., for the CPE 610 to self-diagnose motor performance degradation or failure. An example of such a condition can be a threshold for CPE data traffic above which the CPE 610 should avoid performing the self-diagnosis. For instance, the configuration may specify that the CPE 610 should not perform the motor health check if the CPE 610 is handling (e.g., transmitting and/or receiving) data traffic in excess of a predetermined level of data traffic. As another example, the condition may identify time periods during which the CPE 610 may or may not perform the motor health check. For instance, the configuration may identify time periods during which CPE data traffic is presumed to be low (e.g., evenings, nights, weekends, holidays, etc.) and as such the self-diagnosis may be performed. Similarly, the configuration may identify time periods during which CPE data traffic is presumed to be high (e.g., work weekdays, special events, crowded events, etc.) and as such the motor health check should not be performed.

In some aspects, the configuration may configure the CPE 610 with reporting parameters related to the CPE 610's reporting of the results of its motor health check or motor performance degradation self-diagnosis. For example, the configuration may configure the CPE 610 with reporting periods for the CPE 610 to report the results of the motor health check to the BS 620. As another example, the configuration may configure the CPE 610 with frequency bands to use for the reporting the results of the motor health check to the BS 620. As discussed above, the functionalities and capabilities of the CPE 610 can include 5G, FR1/sub-6 GHz, FR3, Wi-Fi based on IEEE 802.11 standards, and/or FR2/mmWave, frequency bands. The configuration may then configure the CPE 610 to report the results of the motor health check via one or more of these frequency ranges.

In some aspects, the configuration may configure the CPE 610 with the manner the CPE 610 should conduct the motor health check, i.e., with the manner the CPE 610 should perform the motor performance degradation or failure self-diagnosis. In some aspects, the configuration may configure the CPE 610 to trigger the motor to move the antenna panel from a first position (e.g., position P1 in FIG. 3) to a second position (e.g., position P2 in FIG. 3) to initiate the self-diagnosis. As discussed above with reference to FIG. 3, the movement of the antenna panel can be linear (e.g., in the x-direction and/or the y-direction) and/or angular (e.g., rotational motion).

At step 640, the CPE 610 may trigger the motor to move the antenna panel from a first position to a second position linearly and/or angularly, as noted above and discussed in more details with reference to FIG. 2. For example, the motor may translate the antenna panel in the x-direction and/or the y-direction in a linear manner along the 2-dimensional plane of the CPE (e.g., on the bottom plane 260 of the CPE 200 in FIG. 2 or in a plane parallel to the bottom plane 260). Instead of or in addition to the linear motion, the motor may rotate the antenna panel angularly, e.g., in clockwise direction or anticlockwise direction.

At step 650, the CPE 610 may determine the performance of the motor moving the antenna panel from the first position to the second position. That is, the CPE 610 may determine any performance degradation or failure of the motor based on the motor's movement of the antenna panel (step 640). In some aspects, the CPE 610 may compare a metric associated with the motor-caused motion of the antenna panel from the first position to the second position, and may compare this metric with expected operational parameter of the motor. The CPE 610 may then determine the health of the motor, e.g., whether the motor has any performance degradation or failure, based on the comparison. The expected operational parameter of the motor can be an operational parameter of the motor when the motor is known to have no defects or no performance degradation or failure (e.g., when the motor is brand new, when the motor has been inspected and attested as being non-defective or fully functional by a technician, etc.).

In some aspects, the operational parameter of the motor can be a speed with which a non-defective fully functional motor is configured or designed to move the antenna panel when moving the antenna panel from the first position to the second position (referred as “expected speed” for ease of description). The expected speed can be an expected linear speed of the antenna panel if the motion of the antenna panel is linear and/or an expected angular speed of the antenna panel if the motion of the antenna panel is angular (i.e., rotational).

In such cases, the metric associated with the motion of the antenna panel can be the actual speed of the antenna panel when it was moved (e.g., rotated) by the motor from the first position to the second position. In some cases, the CPE 610 may have a speed measuring device such as but not limited to a speedometer, an accelerometer, a tachometer, and/or the like, and may use said speed-measuring device to measure the actual speed of the antenna panel as it is moving from the first position to the second position.

In some aspects, the CPE 610 may compare the actual speed of the antenna panel to the expected speed. In some cases, the comparison may show that the actual speed of the antenna panel is different from the expected speed by more than a threshold amount (e.g., by more than about 1%, about 3%, about 5%, about 10%, etc.). In such cases, the CPE 610 may determine based on the comparison that the motor has suffered performance degradation or failure. That is, the CPE 610 may make the determination that the motor is functioning abnormally or has failed. On the other hand, the comparison may show that the actual speed of the antenna panel is within a threshold range of the expected speed (e.g., within about 1%, about 3%, about 5%, about 10%, etc., of the expected speed). In such cases, the CPE 610 may determine based on the comparison that the motor has not suffered performance degradation or failure. That is, the CPE 610 may make the determination that the motor is functioning normally and has not experienced failure.

In some aspects, the operational parameter of the motor can be an amount of time a non-defective fully functional motor is configured or designed to take when moving (e.g., rotating) the antenna panel from the first position to the second position (referred as “expected time” for ease of description). In such cases, the metric associated with the motion of the antenna panel can be the actual time it takes the antenna panel to move from the first position to the second position when moved by the motor. For example, the CPE 610 may have a time measuring device such as a timer, and may use said time-measuring device to measure the actual time the antenna panel takes as it is being moved from the first position to the second position by the motor.

In some aspects, the CPE 610 may compare the actual time to the expected time. In some cases, the comparison may show that the actual time is different from the expected time by more than a threshold amount (e.g., by more than about 1%, about 3%, about 5%, about 10%, etc.). In such cases, the CPE 610 may determine based on the comparison that the motor has suffered performance degradation or failure. That is, the CPE 610 may make the determination that the motor is functioning abnormally or has failed. On the other hand, the comparison may show that the actual time of the antenna panel is within a threshold range of the expected time (e.g., within about 1%, about 3%, about 5%, about 10%, etc., of the expected time). In such cases, the CPE 610 may determine based on the comparison that the motor has not suffered performance degradation or failure. That is, the CPE 610 may make the determination that the motor is functioning normally and has not experienced failure.

In some aspects, the operational parameter of the motor can be the acceleration or deceleration with which a non-defective fully functional motor is configured or designed to accelerate or decelerate the antenna panel when moving it from the first position to the second position (referred as “expected acceleration” for ease of description - since deceleration is negative acceleration, it will also be referred to as acceleration herein). The expected acceleration can be an expected linear acceleration of the antenna panel if the motion of the antenna panel is linear and/or an expected angular acceleration of the antenna panel if the motion of the antenna panel is angular (i.e., rotational).

In such cases, the metric associated with the motion of the antenna panel can be the actual acceleration of the antenna panel when it was moved (e.g., rotated) by the motor from the first position to the second position. In some cases, the CPE 610 may have an acceleration measuring device such as but not limited to an accelerometer, a tachometer, and/or the like, and may use said acceleration-measuring device to measure the actual acceleration of the antenna panel as it is moving from the first position to the second position.

In some aspects, the CPE 610 may compare the actual acceleration of the antenna panel to the expected acceleration. In some cases, the comparison may show that the actual acceleration of the antenna panel is different from the expected acceleration by more than a threshold amount (e.g., by more than about 1%, about 3%, about 5%, about 10%, etc.). In such cases, the CPE 610 may determine based on the comparison that the motor has suffered performance degradation or failure. That is, the CPE 610 may make the determination that the motor is functioning abnormally or has failed. On the other hand, the comparison may show that the actual acceleration of the antenna panel is within a threshold range of the expected acceleration (e.g., within about 1%, about 3%, about 5%, about 10%, etc., of the expected speed). In such cases, the CPE 610 may determine based on the comparison that the motor has not suffered performance degradation or failure. That is, the CPE 610 may make the determination that the motor is functioning normally and has not experienced failure.

In some aspects, the operational parameter of the motor can be the energy a non-defective fully functional motor is configured or designed to consume to move its antenna panel from the first position to the second position (referred as “expected energy usage” for ease of description). In such cases, the metric associated with the motion of the antenna panel can be the actual energy usage of the motor as it is moving (e.g., rotating) the antenna panel from the first position to the second position. In some cases, the CPE 610 may have an energy meter such as but not limited to a battery monitor, a wattmeter, and/or the like, and may use said energy meter to measure the actual energy usage of the motor as it is moving the antenna panel from the first position to the second position. For example, the energy can be obtained based on current consumption of the motor and the voltage rail in the motor used (e.g., by multiplying the current consumption by the voltage).

In some aspects, the CPE 610 may compare the actual energy usage of the motor to the expected energy usage. In some cases, the comparison may show that the actual energy usage of the motor is different from the expected energy usage by more than a threshold amount (e.g., by more than about 1%, about 3%, about 5%, about 10%, etc.). In such cases, the CPE 610 may determine based on the comparison that the motor has suffered performance degradation or failure. That is, the CPE 610 may make the determination that the motor is functioning abnormally or has failed. On the other hand, the comparison may show that the actual energy usage is within a threshold range of the expected energy usage (e.g., within about 1%, about 3%, about 5%, about 10%, etc., of the expected speed). In such cases, the CPE 610 may determine based on the comparison that the motor has not suffered performance degradation or failure. That is, the CPE 610 may make the determination that the motor is functioning normally and has not experienced failure.

In some aspects, the operational parameter of the motor can be the thermal overhead a non-defective fully functional motor is configured or designed to generate when moving (e.g., rotating) its antenna panel from the first position to the second position (referred as “expected thermal overhead” for ease of description). In some instances, the term “thermal overhead” may refer to the increase in the temperature of the motor and/or the CPE 610 that is caused as a result of the motor operating to move the antenna panel. In such cases, the metric associated with the motion of the antenna panel can be the thermal overhead generated by the motor as it is causing the antenna panel to move from the first position to the second position. In some cases, the CPE 610 may have a thermometer, or in general a temperature monitoring device configured to measure the thermal overhead, and may use said thermometer or device to measure the actual thermal overhead generated by of the motor as it is moving the antenna panel from the first position to the second position.

In some aspects, the CPE 610 may compare the actual thermal overhead to the expected thermal overhead. In some cases, the comparison may show that the actual thermal overhead is different from the expected thermal overhead by more than a threshold amount (e.g., by more than about 1%, about 3%, about 5%, about 10%, etc.). In such cases, the CPE 610 may determine based on the comparison that the motor has suffered performance degradation or failure. That is, the CPE 610 may make the determination that the motor is functioning abnormally or has failed. On the other hand, the comparison may show that the actual thermal overhead is within a threshold range of the expected thermal overhead (e.g., within about 1%, about 3%, about 5%, about 10%, etc., of the expected speed). In such cases, the CPE 610 may determine based on the comparison that the motor has not suffered performance degradation or failure. That is, the CPE 610 may make the determination that the motor is functioning normally and has not experienced failure.

At step 660, the CPE 610 transmits to the BS 620 a motor performance degradation or failure report including the determined performance of the motor. The report may be transmitted as a RRC, a PDCCH DCI, a GC-PDCCH DCI, and/or a MAC-CE message. In some aspects, the report may include the determination of whether the motor of the CPE 610 is functioning abnormally or has failed, or the motor is functioning normally and has not experienced failure. In the former case, for instance, the report may declare the motor or the CPE 610 to be operating in “abnormal” operational mode (e.g., to indicate that the motor is functioning abnormally or has experienced performance degradation or failure), while in the latter case, the report may declare the motor or the CPE 610 to be operating in “normal” operational mode (e.g., to indicate that the motor is functioning normally and has not experienced performance degradation or failure). In some aspects, the CPE 610 transmits the report to the BS 620 using frequency channels in one or more of 5G, FR1/sub-6 GHz, FR3, Wi-Fi based on IEEE 802.11 standards, and/or FR2/mmWave, frequency ranges. For instance, the CPE 610 may transmit the report to the BS 620 using a mmWave frequency channel while also using a sub-6 GHz frequency channel as a beacon to broadcast the status of the motor in the CPE 610 (e.g., the status that the motor performance has degraded or the motor has failed).

In some aspects, the CPE 610 may include additional information, besides the “abnormal operational mode” declaration, in the report declaring the abnormal operational mode, where the additional information is related to the reasons and/or consequences of the motor's degraded performance or failure. In some instances, the additional information can be limitations on the communication capabilities of the CPE 610 and/or the BS 620 due to the “abnormal operational mode” of the CPE 610. For example, the limitations can include limitations placed on the beamforming capabilities of the CPE 610 and the BS 620 as a result of the motor's failure or abnormal functioning, i.e., as a result of the “abnormal operational mode.” In some aspects, the CPE 610 may not include additional information in the report to avoid potentially unnecessary signaling overhead (e.g., and instead let the BS 620 send a request about the additional information, if desired). For example, the report may not include any of the beamforming limitations associated with the abnormal operational mode.

At step 670, in response to receiving the motor performance degradation or failure report at step 660, the BS 620 may transmit a request for information on beamforming limitations that the CPE 610 is experiencing as a result of the motor's failure or subnormal functioning, i.e., as a result of the “abnormal operational mode.” Beamforming, which may also be referred to as spatial filtering, directional transmission, or directional reception, is a signal processing technique that may be used at a transmitting device or a receiving device (e.g., a BS 105, a CE 115, a CPE, 300, a UE 400) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some aspects, the aforementioned limitations associated with the abnormal operational mode of the CPE (i.e., limitations due to degraded performance by or failure of the motor) may include the unavailability of particular beams for use by the CPE 610 and BS 620 to communicate with each other. Another limitation can be the inability to use signals propagating at a particular orientation for beamforming. For example, as discussed above, performance degradation or failure by the motor may affect the actual speed, actual acceleration, and/or actual time of the movement of the CPE 610's antenna panel as the motor moves it from the first position to the second position. This may result in the antenna panel of the CPE 610 failing to arrive at the second position in a predetermined amount of time (or may entirely fail to arrive at the second position). In such cases, the particular beams and/or beam orientations may not be available for beamforming between the CPE 610 and BS 620 (e.g., because the CPE 610 is not positioned at the second location and/or is not properly oriented).

At step 680, in some aspects, the CPE 610 may transmit to the BS 620 the requested information in response to receiving the request for information on beamforming limitations from the BS 620 (at step 670). For example, the response may indicate the beam and/or beam orientation that are unavailable for use for beamforming (e.g., and as such the BS 620 may not use in communicating with the CPE 610).

FIG. 7 illustrates a signaling diagram illustrating a first method 700 of a CPE diagnosing performance degradation or failure of a motor of the CPE, in accordance with one or more aspects of the present disclosure. The method 700 is implemented between a CPE 710 (e.g., the CEs 115, CPE 200, 300), a UE 720 (e.g., CEs 115, UE 400), and a BS 730 (e.g., the BSs 105 and 500) in a network (e.g., the network 100). Steps of the method 700 can be executed by computing devices (e.g., a processor, processing circuit, and/or other suitable component) of the CPE 710, the UE 720, and the BS 730. As illustrated, the method 700 includes a number of enumerated steps, but aspects of the method 700 may include additional steps before, after, and in between the enumerated steps. In some aspects, one or more of the enumerated steps may be omitted or performed in a different order. The method 700 may employ any suitable combinations of features described herein with respect to FIGS. 1-6, and 8-9, respectively.

At step 740, the BS 720 transmits to the CPE 710 a configuration to configure the CPE with a UE assisted-diagnosis mode. In some aspects, the configuration may be transmitted via a signaling message (e.g., over-the-air signaling) such as but not limited to a radio resource control (RRC), a physical downlink control channel (PDCCH) downlink control information (DCI), and/or group-common-PDCCH (GC-PDCCH) DCI. In some aspects, the UE assisted-diagnosis (UEad) mode configuration may configure the CPE 610 to communicate with a UE in the network that the CPE is in to determine the health or performance of the motor of the CPE 710 that is coupled to the antenna panel of the CPE 710. As discussed above, the CPE 710 may have a motor (e.g., such as the motor 270 in FIG. 2 or motor 309 in FIG. 3) that is coupled to antenna panel of the CPE 710 and is configured to move the antenna panel. The UEad mode configuration then configures the CPE 610 to establish a sidelink communication channel with the UE 720 and use the UE 720 to perform health check on the motor. The health check on the motor may determine any performance degradation or failure associated with the motor of the CPE 610. The terms “motor health check” and “motor performance degradation/failure diagnosis” may be used interchangeably.

In some aspects, a sidelink communication channel may be a channel between two devices (e.g., two CPEs 710, two UEs 720, or a CPE 710 and a UE 720) to communicate directly with each other without using a base station 105 as an intermediary for the communication. For example, the sidelink communication channel between the CPE 710 and the UE 720 may be a peer-to-peer (P2P) communication channel, a device-to-device (D2D) communication channel, a mesh network communication channel, and/or the like. In these cases, the CPE 710 and/or the UE 720 may perform scheduling operations, resource selection operations, etc., needed for the communication between the CPE 710 and the UE 720 and described herein as being performed by the BS.

In some aspects, there may be two UEad mode types, hereinafter referred to as UEad mode 1 and UEad mode 2. In such cases, the configuration from the BS 730 may configure the CPE 710 with one or both of UEad mode 1 or UEad mode 2. In some aspects, UEad mode 1 refers to a UEad where the communication between PCE 710 and UE 720 via the sidelink communication channel is facilitated by the BS 730. For example, the BS 730 may convey to the CPE 710 information on the CPE 710's normal operational mode of communication with the UE 720. For instance, the BS 730 may indicate to the CPE 710 the direction that the CPE 710 can use to communicate with the UE 720. Further, the BS 730 may also convey to the CPE 710 the strength of the signal that the CPE 710 may have to use when communicating with the UE 720 via the sidelink communication channel. That is, the BS 730 may provide to the CPE 710 the strength of the signal that the CPE 710 is expected to use when communicating with UE 720. In some aspects, the configuration may indicate the expected signal strength or quality based on a reference signal received power (RSRP), a reference signal received quality (RSRQ), a signal-to-interference-plus-noise ratio (SINR), a signal-to-noise ratio (SNR), or a received signal strength indicator (RSSI), of the signal that the CPE 710 may have to use when communicating with the UE 720.

In some aspects, the BS 720 may determine the expected signal strength that the CPE 710 may have to use to communicate with the UE 720 based on a digital twin of the CPE 710. A digital twin of the CPE 710 refers to a virtual representation of the CPE 710 that the BS 730 creates by applying simulation and modeling techniques to real-time data of the CPE 710 to mirror the CPE 710. In some aspects, the BS 730 can create a digital twin or the CPE 710 (e.g., based on real-time data the BS 730 collects about the CPE 710). The BS 730 can then determine, based on the digital twin, the expected signal strength that the CPE 710 has to use for its communication with the UE 720.

In some aspects, UEad mode 2 refers to a UEad where the communication between PCE 710 and UE 720 via the sidelink communication channel is established by the CPE 710 autonomously. For example, in contrast to the BS 730 conveying the communication direction to the CPE 710 under UEad mode 1, under UEad mode 2, the CPE 710 may autonomously determine the communication direction based on beam training.

Beam training may be a procedure used to refine transmission and reception beams and may be referred to as a beam management procedure. There may be different steps to beam training, such as P1, P2, and P3. During P1, BS 730 may transmit an indication of a wide beam to CPE 710. For example, BS 730 may transmit an indication to CPE 710 to use a wide beam. During P2, CPE 710 may divide the indicated wide beam into some number of narrow beams, where the narrow beams may fit within the wide beam. CPE 710 may then transmit on each of the narrow transmission beams to UE 720. UE 720 may receive each of the narrow transmission beams on all reception antenna panels or on a subset of antenna panels. UE 720 may then measure the quality of each transmission beam based on RSRP, RSRQ, SINR, SNR, RSSI, and/or the like. UE 720 may report the measurements to CPE 710 and/or BS 730. In some cases, UE 720 may transmit an indication of one or more transmission beams (e.g., one or more of the best transmission beams) to CPE 710 and/or BS 730. CPE 710 and/or BS 730 may determine one or more transmission beams (e.g., one or more of the best transmission beams) based on the measurements and/or preferred transmission beam indicated by UE 720. The one or more selected narrow transmission beams may also be selected based on cell conditions.

During P3, CPE 710 may transmit to UE 720 on the one or more selected narrow transmission beams for some amount of time. UE 720 may receive the signal from the selected transmission beams using different panel and beam configurations. For example, the UE 720 may receive signals on a pair of reception beams, on one reception beams, on more than two reception beams, on multiple beams from different antenna panels, on multiple reception beams from the same panels, etc. UE 720 may measure each of the signals received from the selected transmission beam on each reception beam and transmit a measurement report to BS 730 and/or CPE 710. In some cases, UE 720 indicates one or more preferred reception beams to CPE 710 and/BS 730. CPE 710 and/or BS 730 may select one or more reception beams from the receiving UE 115 based on the measurements and/or indication of a preferred beam. The one or more preferred reception beams may be selected based on cell conditions such as other communications occurring nearby to avoid potential interference from or to neighboring devices.

In some aspects, under UEad mode 2, the CPE 710 may also autonomously determine the normal operational mode of communication with the UE 720 based on past history of beamforming to the UE 720. For example, the CPE 710 may determine the expected strength of the signal that the CPE 710 may use to communicate with the UE 720 (e.g., using a sidelink communication channel). For instance, in contrast to the BS 730 conveying the expected signal strength to the CPE 710 under UEad mode 1, under UEad mode 2, the CPE 710 may autonomously determine the expected signal strength based on previous beamforming to the UE 720. That is, the CPE 710 may have determined best signal strength or quality to use for communicating with the UE 720 during previous beamforming to the UE 720 (e.g., based on RSRP, RSRQ, SINR, SNR, RSSI, and/or the like). Then, the CPE 710 may identify that determined signal strength as the expected signal strength to use for communicating with the UE 720 via the sidelink communication channel.

At step 745, the CPE 710 may position and/or orient its antenna panel to communicate along the intended direction and then trigger the motor to move the antenna panel from a first position to a second position. Under UEad mode 1, the intended direction can be the direction the BS 730 indicated in the UE assisted-diagnosis configuration 740 that the CPE 710 can use to communicate with the UE 720. Under UEad mode 2, the intended direction can be the communication direction the CPE 710 autonomously determined based on beam training.

In some aspects, after the antenna panel is oriented by the CPE 710 to communicate with the UE 720 along the intended direction, the CPE 710 may move the antenna panel linearly and/or angularly, as noted above and discussed in more details with reference to FIG. 2. For example, the motor may translate the antenna panel in the x-direction and/or the y-direction in a linear manner along the 2-dimensional plane of the CPE (e.g., on the bottom plane 260 of the CPE 200 in FIG. 2 or in a plane parallel to the bottom plane 260). Instead of or in addition to the linear motion, the motor may rotate the antenna panel angularly, e.g., in clockwise direction or anticlockwise direction.

At step 750, the CPE 710 may beamform to the UE 720 via the sidelink communication channel as the antenna panel is moving (e.g., rotating, moving linearly) from the first position to the second position (e.g., as the motor is moving the antenna panel as discussed above with reference to step 745). That is, the CPE 710 may perform beamforming operation to transmit a signal to the UE 720. For example, the signal can be a PSSCH, SCI, etc.

At step 755, in some aspects, the UE 720 measures snapshot values of the strength of the signal from the CPE 710. In other aspects, the UE 720 may measure the steady state values of the strength of the signal from the CPE 710. The measurements of snapshots and/or steady state values of the signal from the CPE 710 may be based on RSRP, RSRQ, SINR, SNR, RSSI, and/or the like, of the signal from the CPE 710.

At step 760, the UE 720 may report the measurements to the CPE 710. For example, the UE 720 may transmit a signal strength report via the sidelink communication channel established between the UE 720 and the CPE 710 to provide the CPE 710 the snapshot values and/or steady state values of the strength of the signal transmitted by the CPE 710 to the UE 720. For example, the signal strength report may include RSRP, RSRQ, SINR, SNR, RSSI, and/or the like, values of the snapshot and/or steady-state measurements of the signal transmitted by the CPE 710 to the UE 720.

At step 765, the CPE 710 may determine the performance of the motor moving the antenna panel from the first position to the second position. That is, the CPE 710 may determine any performance degradation or failure of the motor based on the motor's movement of the antenna panel (step 745). In some aspects, the CPE 710 may determine the motor's performance by comparing the signal strength indicated in the signal strength report to an expected signal strength of the CPE during the motion of the antenna panel. As discussed above, under UEad mode 1, the expected signal strength is provided to the CPE 710 by the BS 730. That is, the BS 730 may create a digital twin of the CPE 710 and use the digital twin to determine an expected signal strength that the CPE 710 may use to communicate with the UE 720. Under UEad mode 2, the expected signal strength is determined autonomously by the CPE 710 based on previous beamforming to the UE 720.

In some aspects, the CPE 710 may compare the CPE 710's signal strength indicated in the signal strength report from the UE 720 with the expected signal strength from the BS 730 (e.g., under UEad mode 1) or determined autonomously by the CPE 710 (e.g., under UEad mode 2). In some instances, the reported signal strength values can be snapshot values, in which case the CPE 710 may compare these values to expected snapshot signal strength values (e.g., either from the BS 730 and/or determined autonomously by the CPE 710). In other instances, the reported signal strength values can be stead state values, in which case the CPE 710 may compare these values to expected steady state signal strength values (e.g., either from the BS 730 and/or determined autonomously by the CPE 710). In some aspects, the CPE 710 may then determine the health of the motor, e.g., whether the motor has any performance degradation or failure, based on the comparison.

In some aspects, the comparison may show that the reported signal strength is different from the expected signal strength. For instance, under UEad mode 1, the comparison may show that the expected signal strength that the BS 730 provided to the CPE 710 (e.g., the signal strength that the BS 730 indicated to the CPE 710 to use when communicating to the UE 720) may be different from the actual signal strength that the CPE 710 used (e.g., as measured by the UE 720 and reported in the signal strength report). As another example, under UEad mode 2, the comparison may show that the expected signal strength that the CPE 710 determined based on previous beamforming experience to the UE 720 (e.g., and expected to use when communicating to the UE 720 the sidelink signal at step 750) may be different from the actual signal strength that the CPE 710 used (e.g., as measured by the UE 720 and reported in the signal strength report).

In some aspects, a difference between the reported/actual signal strength and the expected signal strength for a UEad mode may be by more than a threshold amount (e.g., by more than about 1%, about 3%, about 5%, about 10%, etc.). In such cases, the CPE 710 may determine based on the comparison that the motor has suffered performance degradation or failure. That is, the CPE 710 may make the determination that the motor is functioning abnormally or has failed. On the other hand, the comparison may show that a difference between the reported/actual signal strength and the expected signal strength for a UEad mode may be within a threshold amount (e.g., within about 1%, about 3%, about 5%, about 10%, etc.) of the expected speed. In such cases, the CPE 710 may determine based on the comparison that the motor has not suffered performance degradation or failure. That is, the CPE 710 may make the determination that the motor is functioning normally and has not experienced failure.

At step 770, the CPE 710 transmits to the BS 720 a motor performance degradation or failure report including the determined performance of the motor. The report may be transmitted as a RRC, a MAC-CE, etc., message. In some aspects, the report may include the determination of whether the motor of the CPE 710 is functioning abnormally or has failed, or the motor is functioning normally and has not experienced failure. In the former case, for instance, the report may declare the motor or the CPE 710 to be operating in “abnormal” operational mode (e.g., to indicate that the motor is functioning abnormally or has experienced performance degradation or failure), while in the latter case, the report may declare the motor or the CPE 710 to be operating in “normal” operational mode (e.g., to indicate that the motor is functioning normally and has not experienced performance degradation or failure). In some aspects, the CPE 710 transmits the report to the BS 730 using frequency channels in one or more of 5G, FR1/sub-6 GHz, FR3, Wi-Fi based on IEEE 802.11 standards, and/or FR2/mmWave, frequency ranges. For instance, the CPE 710 may transmit the report to the BS 720 using a mmWave frequency channel while also using a sub-6 GHz frequency channel as a beacon to broadcast the status of the motor in the CPE 710 (e.g., the status that the motor performance has degraded or the motor has failed).

In some aspects, the CPE 710 may include additional information, besides the “abnormal operational mode” declaration, in the report declaring the abnormal operational mode, where the additional information is related to the reasons and/or consequences of the motor's degraded performance or failure. In some instances, the additional information can be limitations on the communication capabilities of the CPE 710 and/or the BS 730 due to the “abnormal operational mode” of the CPE 710. For example, the limitations can include limitations placed on the beamforming capabilities of the CPE 710 and the BS 730 as a result of the motor's failure or abnormal functioning, i.e., as a result of the “abnormal operational mode.” In some aspects, the CPE 710 may not include additional information in the report to avoid potentially unnecessary signaling overhead (e.g., and instead let the BS 730 send a request about the additional information, if desired). For example, the report may not include any of the beamforming limitations associated with the abnormal operational mode.

At step 775, in response to receiving the motor performance degradation or failure report at step 770, the BS 730 may transmit a request for information on beamforming limitations that the CPE 710 is experiencing as a result of the motor's failure or subnormal functioning, i.e., as a result of the “abnormal operational mode.” In some aspects, the aforementioned limitations associated with the abnormal operational mode of the CPE (i.e., limitations due to degraded performance by or failure of the motor) may include the unavailability of particular beams for use by the CPE 710 and BS 730 to communicate with each other. Another limitation can be the inability to use signals propagating at a particular orientation for beamforming. For example, as discussed above, performance degradation or failure by the motor may affect the actual speed, actual acceleration, and/or actual time of the movement of the CPE 710's antenna panel as the motor moves it from the first position to the second position. This may result in the antenna panel of the CPE 710 failing to arrive at the second position in a predetermined amount of time (or may entirely fail to arrive at the second position). In such cases, the particular beams and/or beam orientations may not be available for beamforming between the CPE 710 and BS 730 (e.g., because the CPE 710 is not positioned at the second location and/or is not properly oriented).

At step 780, in some aspects, the CPE 710 may transmit to the BS 730 the requested information in response to receiving the request for information on beamforming limitations from the BS 730 (at step 775). For example, the response may indicate the beam and/or beam orientation that are unavailable for use for beamforming (e.g., and as such the BS 730 may not use in communicating with the CPE 710).

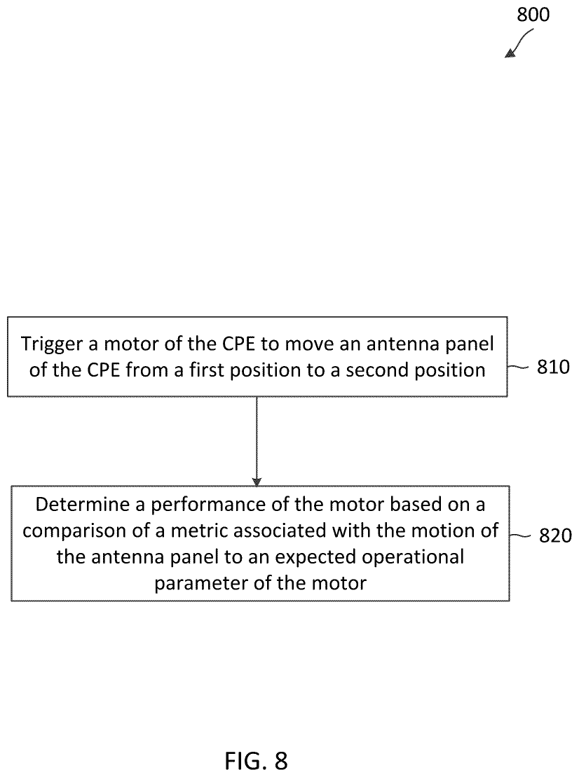

FIG. 8 illustrates a flow diagram of a method 800 performed by a CPE to self-diagnose performance degradation or failure of a motor moving an antenna panel of the CPE, in accordance with one or more aspects of the present disclosure. Blocks of the method 800 can be executed by a computing device (e.g., a processor, processing circuit, and/or other suitable component) of a wireless communication device. In some aspects, the wireless communication device is a CPE (e.g., CEs 115, CPE 200, 300, 610, and/or 710) that may utilize one or more components, such as the processor 302, the memory 304, the MPD module 308, the transceiver 310, and/or the antennas 316 to execute the blocks of the method 800. As illustrated, the method 800 includes a number of enumerated blocks, but aspects of the method 800 may include additional blocks before, after, and/or in between the enumerated blocks. In some aspects, one or more of the enumerated blocks may be omitted or performed in a different order.

At block 810, the method 800 includes triggering, by a CPE, a motor of the CPE to move an antenna panel of the CPE from a first position to a second position. In some aspects, the motion of the antenna panel includes rotational motion of the antenna panel. In some aspects, the motion of the antenna panel includes translational motion of the antenna panel.

At block 820, the method 800 includes determining, by the CPE, a performance of the motor based on a comparison of a metric associated with the motion of the antenna panel to an expected operational parameter of the motor. In some aspects, the operational parameter of the motor includes at least one of a speed, an acceleration, a duration, an energy usage, or a thermal overhead, associated with the motion of the antenna panel.

In some aspects, the method 800 further comprises receiving, by the CPE, a configuration from the network entity configuring the CPE with a self-diagnosis mode to determine the performance of the motor. In some aspects, the configuration further configures the CPE with a periodicity of the self-diagnosis mode.

In some aspects, the method 800 further comprises transmitting, by the CPE, a performance report to a network entity indicating the performance of the motor. In some aspects, the method 800 further comprises receiving a request from the network entity requesting information about beamforming limitations associated with the performance of the motor in response to the transmitting the performance report. Further, in some aspects, the transmitting takes place over a millimeter wave (mmW) frequency range.

In some aspects, the method 800 further comprises broadcasting the performance of the motor using a sub-6 GHz frequency range or a frequency range 3 (FR3) range.

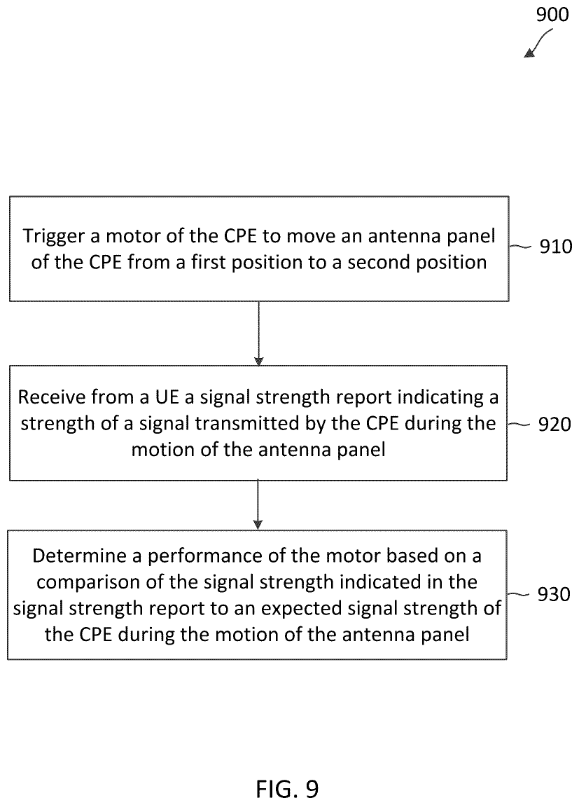

FIG. 9 illustrates a flow diagram of a method 900 performed by a CPE to self-diagnose performance degradation or failure of a motor moving an antenna panel of the CPE, in accordance with one or more aspects of the present disclosure. Blocks of the method 900 can be executed by a computing device (e.g., a processor, processing circuit, and/or other suitable component) of a wireless communication device. In some aspects, the wireless communication device is a CPE (e.g., CEs 115, CPE 200, 300, 610, and/or 710) that may utilize one or more components, such as the processor 302, the memory 304, the antenna MPD module 308, the transceiver 310, and/or the antennas 316 to execute the blocks of the method 900. The method 900 may employ similar aspects as in the method 800 in FIG. 8. As illustrated, the method 900 includes a number of enumerated blocks, but aspects of the method 900 may include additional blocks before, after, and/or in between the enumerated blocks. In some aspects, one or more of the enumerated blocks may be omitted or performed in a different order.

At block 910, the method 900 includes triggering, by a CPE, a motor of the CPE to move an antenna panel of the CPE from a first position to a second position.

At block 920, the method 900 includes receiving, by the CPE and from a UE, a signal strength report indicating a strength of a signal transmitted by the CPE during the motion of the antenna panel. In some aspects, the strength of the signal is a reference signal received power (RSRP), reference signal received quality (RSRQ), signal-to-interference-plus-noise ratio (SINR), signal-to-noise ratio (SNR), or received signal strength indicator (RSSI), of the signal.

At block 930, the method 900 includes determining, by the CPE, a performance of the motor based on a comparison of the signal strength indicated in the signal strength report to an expected signal strength of the CPE during the motion of the antenna panel.

In some aspects, method 900 further comprises receiving, by the CPE, a communication from a network unit indicating at least one of a direction for the CPE to transmit the signal during the motion of the antenna panel or the expected signal strength of the CPE.

In some aspects, method 900 further comprises receiving a communication configuring the CPE to determine, based on beam training, a direction for the CPE to transmit the signal during the motion of the antenna panel. In some aspects, the communication configures the CPE to determine the expected signal strength of the CPE based on previous beamforming behavior associated with the UE.

In some aspects, a CPE comprises a motor, a memory, and a processor. In some aspects, a processor, when executing instructions stored on the memory, configured to:
trigger the motor to move an antenna panel of the CPE from a first position to a second position. Further, the processor is further configured to determine a performance of the motor based on a comparison of a metric associated with the motion of the antenna panel to an expected operational parameter of the motor.

In some aspects, the CPE further comprises a transceiver configured to receive a configuration configuring the CPE with a self-diagnosis mode to determine the performance of the motor. Further, the transceiver may be configured to transmit a performance report to a network unit indicating the performance of the motor. In addition, the transceiver is further configured to receive a request from a network unit requesting information about beamforming limitations associated with the performance of the motor in response to the transmitting of the performance report. The transceiver is configured to at least one of transmit the performance report to the network over a millimeter wave (mmW) frequency range or broadcast the performance of the motor using a sub-6 GHz frequency range or a frequency range 3 (FR3).

While the disclosure may provide examples in the context of UEs or CPEs operating in LTE and NR FR2 networks, the disclosure applies to devices operating in 5G standalone (SA) mode, 5G non-standalone (NSA) mode, 5G NR TDD FR1 (in sub-6 GHz), and 5G NR TDD FR2 (in mmW). The 5G NSA mode refers to a mode of deployment where control plane operations are operated by LTE signal and data plane operations are operated by 5G. The 5G SA mode refers to a mode of deployment where both control and data plane operations are operated by 5G.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method performed by a customer premises equipment (CPE), comprising:
triggering a motor of the CPE to move an antenna panel of the CPE from a first position to a second position; and
determining a performance of the motor based on a comparison of a metric associated with the motion of the antenna panel to an expected operational parameter of the motor.

2. The method of claim 1, further comprising receiving a configuration from the network entity configuring the CPE with a self-diagnosis mode to determine the performance of the motor.

3. The method of claim 2, wherein the configuration further configures the CPE with a periodicity of the self-diagnosis mode.

4. The method of claim 1, further comprising transmitting a performance report transmitted to a network entity indicating the performance of the motor.

5. The method of claim 4, further comprising receiving a request from the network entity requesting information about beamforming limitations associated with the performance of the motor in response to the transmitting the performance report.

6. The method of claim 4, wherein the transmitting takes place over a millimeter wave (mmW) frequency range.

7. The method of claim 1, further comprising broadcasting the performance of the motor using a sub-6 GHz frequency range or a frequency range 3 (FR3) range.

8. The method of claim 1, wherein the operational parameter of the motor includes at least one of a speed, an acceleration, a duration, an energy usage, or a thermal overhead, associated with the motion of the antenna panel.

9. The method of claim 1, wherein the motion of the antenna panel includes rotational motion of the antenna panel.

10. The method of claim 1, wherein the motion of the antenna panel includes translational motion of the antenna panel.

11. A customer premises equipment (CPE), comprising:
a motor;
a memory; and
a processor, when executing instructions stored on the memory, configured to:
trigger the motor to move an antenna panel of the CPE from a first position to a second position; and
determine a performance of the motor based on a comparison of a metric associated with the motion of the antenna panel to an expected operational parameter of the motor.

12. The CPE of claim 11, further comprising a transceiver configured to receive a configuration configuring the CPE with a self-diagnosis mode to determine the performance of the motor.

13. The CPE of claim 11, further comprising a transceiver configured to transmit a performance report to a network unit indicating the performance of the motor.

14. The CPE of claim 13, wherein the transceiver is further configured to receive a request from a network unit requesting information about beamforming limitations associated with the performance of the motor in response to the transmitting of the performance report.

15. The CPE of claim 13, wherein the transceiver is configured to at least one of transmit the performance report to the network over a millimeter wave (mmW) frequency range or broadcast the performance of the motor using a sub-6 GHz frequency range or a frequency range 3 (FR3).

16. A method performed by a customer premises equipment (CPE), comprising:
triggering a motor of the CPE to move an antenna panel of the CPE from a first position to a second position;
receiving from a UE a signal strength report indicating a strength of a signal transmitted by the CPE during the motion of the antenna panel; and
determining a performance of the motor based on a comparison of the signal strength indicated in the signal strength report to an expected signal strength of the CPE during the motion of the antenna panel.

17. The method of claim 16, further comprising receiving a communication from a network unit indicating at least one of a direction for the CPE to transmit the signal during the motion of the antenna panel or the expected signal strength of the CPE.

18. The method of claim 16, further comprising receiving a communication configuring the CPE to determine, based on beam training, a direction for the CPE to transmit the signal during the motion of the antenna panel.

19. The method of claim 16, wherein the communication configures the CPE to determine the expected signal strength of the CPE based on previous beamforming behavior associated with the UE.

20. The method of claim 16, wherein the strength of the signal is a reference signal received power (RSRP), reference signal received quality (RSRQ), signal-to-interference-plus-noise ratio (SINR), signal-to-noise ratio (SNR), or received signal strength indicator (RSSI), of the signal.
